(19) United States
(12) Patent Application Publication
(10) Pub. No.: US 2016/0192641 A1
(43) Pub. Date: Jul. 7, 2016

(54) STABLE EMULSION FORMULATION HINDERING INTERACTION ACROSS THE WATER-OIL INTERFACE

(71) Applicant: Dow AgroSciences LLC, Indianapolis, IN (US)

(72) Inventor: Lei Liu, Carmel, IN (US)

(73) Assignee: Dow AgroSciences LLC, Indianapolis, IN (US)

(21) Appl. No.: 15/068,756

(22) Filed: Mar. 14, 2016

Related U.S. Application Data
(63) Continuation of application No. 12/189,377, filed on Aug. 11, 2008, now abandoned.
(60) Provisional application No. 60/966,793, filed on Aug. 30, 2007.

(51) Int. Cl. A01N 25/10; A01N 43/40; A01N 25/04

(52) U.S. Cl. CPC A01N 25/10; A01N 25/04; A01N 43/40

(57) ABSTRACT

Interactions between components in the internal oil phase and components in the continuous aqueous phase of an oil-in-water emulsion are hindered by the addition of a mixture of polymeric surfactants, which reduces chemical and/or physical instabilities, and improves compatibilities of components in formulations.

This application is a Continuation of U.S. patent Ser. No. 12/189,377 filed on Aug. 11, 2008 and claims the benefit of U.S. Provisional Application Ser. No. 60/966,793 filed on Aug. 30, 2007.

### BACKGROUND OF THE INVENTION

1. Field of the Invention

This invention concerns a novel stable emulsion composition that hinders interactions across the oil-water interface between ingredients in the oil phase and those in the aqueous phase.

2. Background of the Invention

To design an agricultural formulation product, the most important question to be answered is its stability. Failure to meet a set of stability requirements which usually depend on the specific market, application and regulations will certainly lead to failure of its commercialization. There are many causes of formulation instabilities, such as a) chemical instabilities due to reactions between ingredients (actives and/or inerts, etc.), photo-degradations, and oxidations, etc., b) physical instabilities due to phase separations (Oswald ripening, crystallization, sedimentations, creamings, etc.) and c) environmental factors (temperature, humidity/moisture, etc.). In today's agrichemical market, it becomes increasingly common to design formulations to contain multiple active ingredients and their required solvents, safeners, and/or adjuvants, etc., in order to achieve the optimal spectrum, efficacy, and delivery efficiency, which consequently makes formulation stability more and more challenging. Therefore, technologies that can effectively isolate, hinder, or eliminate, adverse reactions or interactions between incompatible ingredients are often critical for a successful product.

The oil-in-water (normal) or water-in-oil (reverse/inverse) emulsion is one of the most common formulation types for many agricultural products, where droplets of oil or water stabilized by surfactant emulsifiers as a discrete phase are uniformly dispersed in water or oil media as a continuous phase. However, many challenges may exist, when oil ingredients or oil soluble ingredients may hydrolyze, or react with ingredients in the aqueous phase, or have high enough solubility in water to cause Oswald Ripening, or on the contrary, when water soluble or dispersible ingredients may react with oil ingredients or have high enough oil solubility to cause Oswald Ripening in oil phase. For example, a composition containing triclopyr butoxyethyl ester and the potassium salt of aminopyralid has been found to be extremely useful for the control of brush and woody plants in range and pasture and industrial vegetation management applications. However, in typical emulsion formulations with the oil-soluble ester herbicide and the water-soluble salt herbicide, the triclopyr butoxyethyl ester is susceptible to hydrolysis to the corresponding acid. As a result of the acid formation, the emulsion deteriorates due to crystal formation of both triclopyr and aminopyralid acids. Another example is a composition containing aqueous dispersions of penoxsulam and diflufenican, and methylated seed oil adjuvant that is found to be very useful for cereal herbicidal applications; but diflufenican has enough solubility in oil to cause rapid crystal growth due to Oswald Ripening which results in emulsion destabilization. In both examples, it would be desirable to have a stable emulsion formulation that provides a barrier to hinder or prevent the undesirable interactions between the internal oil phase and the continuous aqueous phase.

### SUMMARY OF THE INVENTION

The present invention concerns a stable oil-in-water emulsion which comprises:
a) a discrete oil phase comprising oil active ingredients, oil-soluble active ingredients, oil adjuvant or oil solvent, which can react or interact with ingredients in the continuous aqueous phase to cause a chemical or a physical instability;
b) a continuous aqueous phase comprising water, and water soluble or water dispersible ingredients;
c) a first polymeric surfactant comprising an ABA block copolymer having a hydrophilic portion of polyethylene oxide (PEG) and a hydrophobic portion of 12-hydroxystearic acid in an amount from about 1 g/L to about 200 g/L, and a second polymeric surfactant comprising a polyalkylene glycol ether in an amount from about 1 g/L to about 200 g/L; and
d) optionally, other inert formulation ingredients.

Another aspect of the present invention concerns a method of using the stable oil-in water emulsion and optionally diluting it in an aqueous spray mixture for agricultural applications, such as weed management, plant disease management, or insect pest management.

### BRIEF DESCRIPTION OF THE FIGURES

FIG. 1 is a graphic illustration of a comparison of triclopyr butoxyethyl ester hydrolysis of a prior art Formulation A and a stabilized Formulation B of the present invention. Hydrolysis to triclopyr acid in Formulation A is significantly greater that of Formulation B upon accelerated stability tests at 54° C.

### DETAILED DESCRIPTION OF THE INVENTION

This invention provides an oil-in-water emulsion stabilized by a mixture of polymeric surfactants that hinders or prevents adverse interactions and reactions between ingredients of the discrete oil phase and those of the continuous aqueous phase, which may lead to chemical or physical instabilities of the composition.

The oil phase contains water immiscible components, such as solvents, liquid actives, oil soluble actives, adjuvants or other desirable ingredients that are essentially water immiscible. In a typical oil-in-water emulsion, the oil phase forms discrete droplets stabilized by emulsifiers that are suspended in a continuous aqueous phase. Interactions or reactions of the components in oil phase with those in aqueous phase include, but are not limited to, hydrolysis of a component in the oil phase, or degradation of a component in oil phase that is caused by the presence of other components in aqueous phase, or crystal formation and growth (Oswald Ripening) in the aqueous phase from a component in the oil phase due to its relatively high water solubility.

Oil miscible, oil soluble, or oil dispersible agricultural actives that can potentially undergo hydrolysis include, but are not limited to, esters of carboxylate, phosphate, or sulfate pesticides, including benzoic acid herbicides such as dicamba esters, phenoxyalkanoic acid herbicides such as 2,4-D, MCPA or 2,4-DB esters, aryloxyphenoxypropionic acid herbicides such as clodinafop, cyhalofop, fenoxaprop, fluazifop, haloxyfop and quizalofop esters, and pyridinecarboxylic acid herbicides such as fluroxypyr and triclopyr esters, and insecticides such as chlorpyrifos, chlorpyrifos-methyl, and fungicides such as dinocap, kresoxim-methyl, etc.

Oil miscible, oil soluble, or oil dispersible agricultural actives that have high enough water solubilities (c.a.>60 ppm) and high enough melting point to be a solid at ambient condition, and can potentially result in crystal formation and growth in the aqueous phase due to Oswald Ripening include, but limited to, spinosad, spinetoram, imidacloprid, propanil, cyproconazole, acetamiprid, amicarbazone, amidosulfuron, asulam, bentazone, carbaryl, cymoxanil, dicamba, florasulam, myclobutanil, nitrapyrin, picloram, propiconazole, prosulfuron, prothioconazole, pymetrozine, sulfosulfuron, triclopyr, tricyclazole, malathion, diflufenzopyr, etc.

Optionally, oils used for solvent, diluent, or adjuvant purposes include, but are not limited to, petroleum fractions or hydrocarbons such as mineral oil, aromatic solvents, xylene, paraffinic oils, and the like; vegetable oils such as soy bean oil, rape seed oil, olive oil, castor oil, sunflower seed oil, coconut oil, corn oil, cotton seed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like.

For a formulation concentrate which may be further diluted at point of use, the discrete oil phase may range from 1 g/L to 800 g/L, preferably 10 g/L to 500 g/L, of the total composition. It is commonly known that this concentrated formulation may be diluted from 1 to 2000 fold at point of use depending on the agricultural practices.

The aqueous phase contains water as the solvent medium, and optionally water soluble or water dispersible active ingredients. Typically, water in the aqueous phase of the emulsion formulation is used to balance the final composition. Interactions or reactions of an ingredient in the aqueous phase with component(s) of the oil phase include, but are not limited to, crystal formation and growth due to Oswald Ripening of an aqueous dispersed component in oil phase, or degradation of a component in aqueous phase that is caused by the presence of a component in oil phase.

Water dispersible or water soluble actives that have high enough solubility (>60 ppm) in oil phase, and have high enough melting point to be a solid at ambient condition, can potentially cause crystal formation and growth due to Oswald Ripening in the oil phase. Unlike aqueous phase, oil phase can comprise any combinations of oil solvents, oil actives, and/or oil soluble actives or adjuvants in which the solubility of an aqueous component may vary significantly on a case by case basis. For example, diflufenican has >10000 ppm solubility in methylated seed oils, spinosad or spinetoram has >10000 ppm solubilities in petroleum based oils, bitertanol has >1000 ppm solubilities in paraffinic or aromatic oils, penoxsulam has >1000 ppm solubilities in acetochlor, etc. For a given oil phase which is often designed to meet specific market, customer, or application needs, actives or other components in aqueous phase can form and grow large crystals in oil phase due to high solubilities and Oswald Ripening, and result in emulsion destabilization.

Degradation of a component in oil or aqueous phase that is caused by the presence of a component in its opposite aqueous or oil phase is also case by case depending on the specific composition. For example, chlorpyrifos-methyl in an oil phase would degrade when spinosad or spinetoram is present in aqueous phase. γ-Cyhalothrin in oil phase would degrade when spinosad or spinetoram is present in aqueous phase. Florasulam in oil phase or aqueous phase would degrade in the presence of amine or alkaline functionalities in the opposite phases. Dinocap or meptyl-dinocap in oil phase would degrade when triazole compounds or alkaline chemicals are present in aqueous phase.

The first polymeric surfactant is comprised of an ABA block copolymer having a hydrophilic portion of polyethylene oxide (PEG) and a hydrophobic portion of 12-hydroxystearic acid. A preferred example of such a polymeric surfactant is the commercial surfactant Atlox™ 4912 (trademark of Uniqema), having a molecular weight of about 5,000. Another example of such a polymeric surfactant is the commercial surfactant Termul™ 2510 (trademark of Huntsman). The first polymeric surfactant is present in an amount from about 1 g/L to about 200 g/L, preferably from about 10 g/L to about 100 g/L.

The second polymeric surfactant is comprised of a polyalkylene glycol ether. A preferred example of such a polymeric surfactant is the commercial surfactant Atlas™ G-5000 (EO-PO block copolymer; trademark of Uniqema). Another example of such a polymeric surfactant is the commercial surfactant Termul™ 5429 (alcohol alkoxylate; trademark of Huntsman). The second polymeric surfactant is present in an amount from about 1 g/L to about 200 g/L, preferably from about 10 g/L to about 100 g/L.

In a typical procedure for preparing the oil-in-water emulsion of the present invention, the aqueous phase is prepared by mixing water with water soluble or water dispersible ingredients including, but not limited to, actives, surfactant (polyalkylene glycol ether, e.g., Atlas G-5000), and optionally other inert ingredients such as thickeners, pH buffer, dispersant, wetting agent, biocide, etc. In case of a water-insoluble solid active (e.g. diflufenican, penoxsulam), the solid materials may be milled to a desirable size range (e.g. 0.1-10 μm) and preferably pre-dispersed in a concentrated aqueous dispersion with the help of wetting and dispersing agents. There are many commercially available milling and dispersing processes and equipment that can be used for this purpose which are well known to those skilled in the art. The oil phase is prepared by mixing the oil-soluble ABA block copolymer having a hydrophilic portion of polyethylene oxide (PEG) and a hydrophobic portion of 12-hydroxystearic acid (e.g., Atlox 4912) with oil miscible or soluble ingredients, including but not limited to, oil solvents, oil actives, oil soluble actives, oil adjuvants, oil safeners, etc. The final emulsion formulation is prepared by slowly adding the oil phase into the aqueous phase under high shear homogenization until the desired emulsion droplet size (0.1-10 μm) is achieved

An example of an emulsion in which the chemical instability is hydrolysis of an oil-soluble pesticidal ester by the interaction with the aqueous phase comprises:
a) a discontinuous oil phase comprising from about 1 g/L to about 700 g/L of triclopyr butoxyethyl ester;
b) a continuous aqueous phase comprising from about 100 g/L to about 990 g/L of water and from about 1 g/L to about 300 g/L of a salt of aminopyralid;
c) from about 1 g/L to about 200 g/L of a first polymeric surfactant comprising an ABA block copolymer having a hydrophilic portion of polyethylene oxide (PEG) and a hydrophobic portion of 12-hydroxystearic acid, and from about 1 g/L to about 200 g/L of a second polymeric surfactant comprising a polyalkylene glycol ether; and
d) optionally, other inert formulation ingredients.

An example of an emulsion in which the physical instability is crystal growth due to Oswald Ripening comprises:
a) a discontinuous oil phase comprising from about 1 g/L to about 700 g/L of methyl soyate;
b) a continuous aqueous phase comprising a dispersion of from about 1 g/L to about 500 g/L of penoxsulam, from about 1 g/L to about 500 g/L of diflufenican and from about 200 g/L to about 990 g/L of water;
c) from about 1 g/L to about 200 g/L of a first polymeric surfactant comprising an ABA block copolymer having a hydrophilic portion of polyethylene oxide (PEG) and a hydrophobic portion of 12-hydroxystearic acid, and from about 1 g/L to about 200 g/L of a second polymeric surfactant comprising a polyalkylene glycol ether; and
d) optionally, other inert formulation ingredients.

In addition to the compositions and uses set forth above, the present invention also embraces the composition and use of these emulsions in combination with one or more additional compatible ingredients. Other additional ingredients may include, for example, one or more other pesticides, dyes, and any other additional ingredients providing functional utility, such as, for example, stabilizers, fragrants, viscosity-modifying additives, suspension aids, dispersants, and freeze-point depressants.

The following examples illustrate the present invention.

### Example 1

### Hydrolysis of Triclopyr Butoxyethyl Ester Stored at 54° C.

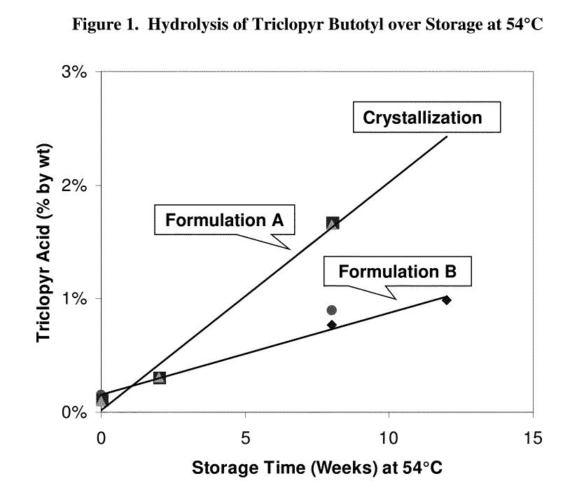

Formulation A, a comparative formulation containing 30.7 wt percent triclopyr butoxyethyl ester, 3.3 wt percent aminopyralid potassium salt, 9.65 wt percent Synperonic A2 (C₁₂-C₁₅ fatty alcohol ethoxylate 3EO), 6.4 wt percent Tensiofix 96DB08 (non-ionic EO-PO block copolymer) with water and Dowanol DPM making up the balance of the ingredients, and Formulation B, a formulation of the present invention containing 29.4 wt percent triclopyr butoxyethyl ester, 3.1 wt percent aminopyralid potassium salt, 2.9 wt percent Atlox 4912 (ABA block copolymer of poly-hydroxy-stearic acid copolymerized polyethylene glycol), 2.9 wt percent Atlas G-5000 (EO-PO block copolymer), 4.4 wt percent propylene glycol, with water, and minor ingredients such as methylcellulose (thickener), xanthan gum (thickener), antifoam, proxel GXL (biocide), monobasic and dibasic potassium phosphate (pH buffer) making up the balance of the ingredients, were stored at 54° C. and monitored for hydrolysis of triclopyr butoxyethyl ester. FIG. 1 compares the hydrolysis of triclopyr butoxyethyl ester to triclopyr acid of the two formulations at 54° C. The generation of triclopyr acid was about 3-fold slower in Formulation B than that in Formulation A which indicates the combination of two polymeric surfactants, Atlox 4912 and Atlas G-5000, formed a much denser, tighter, or rigid interface that hindered the interaction and hydrolysis reaction between triclopyr butoxylethyl ester and water. As a result, Formulation B stays stable after 24 months at ambient or 6 months at 54° C., while Formulation A would form crystals of triclopyr acid and aminopyralid acid after ˜8 months at ambient or 2 months at 54° C.

### Example 2

### Stability of Diflufenican in the Presence of Methyl Soyate

Seven oil-in-water emulsions containing 5 wt percent diflufenican, 0.75 wt percent penoxsulam in aqueous suspension, 5 wt percent propylene glycol, 37.5 wt percent methyl soyate as penoxsulam adjuvant in the oil phase, and the surfactants as listed in Table 1 were prepared and tested for freeze-thaw stability after storage under −10° C./40° C. with 24-hour cycle. Due to its relative high solubility in methyl soyate (>1% by wt), diflufenican has strong tendency to undergo Oswald Ripening causing crystallization and crystal growth, which eventually destabilizes the formulation. The stability results are summarized in Table 1. Sample 5 showed significantly better stability under storage conditions than the other six samples which indicated that the combination of polymeric surfactants, Atlox 4912 and Atlas G-5000, formed a much denser, tighter and rigid interface that hindered the transportation and diffusion of diflufenican across the interface, and limited Oswald ripening that would lead to crystallization and crystal growth. As a result, sample 5 stayed stable for >6 weeks under accelerated storage conditions while the other six formulations destabilized and had crystal growth in about 2 weeks.

TABLE 1
Stability of Diflufenican in Presence of Methyl Soyate
All samples contain: 37.5% methyl soyate, 5% propylene glycol,
5% Diflufenican (DFF), 0.75% penoxsulam, water and other
common inert ingredients as balance.
*FT refer to Freeze/Thaw, 24 hour cycle between −10° C. and 40° C.

| | | % Conc. | | % Conc. | Stability Observation | | | | |
|---|---|---|---|---|---|---|---|---|---|
| Sample | Surfactant | Surfactant | Surfactant | Surfactant | | 54° C. after | FT* after 2 | 54° C. after | FT* after 6 |
| ID | #1 | #1 | #2 | #2 | 0 weeks | 2 weeks | weeks | 6 weeks | weeks |
| 1 | Emgard | 6.62% | none | 0.00% | Stable | Stable | Stable | Stable | Stable |
| | 2033-C | | | | emulsion | emulsion | emulsion | Emulsion | emulsion |
| | | | | | | | but DFF | | but severe |
| | | | | | | | crystals | | DFF crystal |
| | | | | | | | growth | | growth |
| 2 | Cognis | 6.62% | none | 0.00% | Stable | Phase | Phase | N/A | N/A |
| | 33851 | | | | emulsion | Separation | separation | | |
| | | | | | | | with severe | | |
| | | | | | | | DFF crystal | | |
| | | | | | | | growth | | |
| 3 | Tensiofix | 4.96% | Tensiofix | 1.66% | Stable | Phase | Phase | N/A | N/A |
| | N9811HF | | N9824HF | | emulsion | Separation | separation | | |
| | | | | | | | with severe | | |
| | | | | | | | DFF crystal | | |
| | | | | | | | growth | | |
| 4 | Atlox 4914 | 2.65% | Atlas G- | 3.97% | Stable | Stable | Stable | Stable | Phase |
| | | | 5000 | | emulsion | emulsion | emulsion | Emulsion | separation |
| | | | | | | | but DFF | | with severe |
| | | | | | | | crystals | | DFF crystal |
| | | | | | | | growth | | growth |
| 5 | Atlox 4912 | 3.31% | Atlas G- | 3.31% | Stable | Stable | Stable | Stable | Stable |
| | | | 5000 | | emulsion | emulsion | emulsion | emulsion | emulsion |
| 6 | Amsul | 3.31% | T-Det C-40 | 1.32% & | Stable | Phase | Stable | Phase | Stable |
| | DMAP 60 | | & Atlas G- | 1.99% | emulsion | Separation | emulsion | Separation | emulsion |
| | | | 5000 | | | | but DFF | | but severe |
| | | | | | | | crystals | | DFF crystal |
| | | | | | | | growth | | growth |
| 7 | Celvol 205 | 2.40% | none | 0.00% | Stable | Stable | Phase | Stable | Phase |
| | | | | | emulsion | emulsion | separation | Emulsion | separation |
| | | | | | | | with DFF | | with severe |
| | | | | | | | crystal | | DFF crystal |
| | | | | | | | growth | | growth |

1-5. (canceled)

6. A stable oil-in-water emulsion which comprises:
a) a discrete oil phase comprising an oil-soluble ester herbicide;
b) a continuous aqueous phase comprising water, and water soluble or water dispersible ingredients;
c) a first polymeric surfactant comprising an ABA block copolymer having a hydrophilic portion of polyethylene oxide (PEG) and a hydrophobic portion of 12-hydroxystearic acid in an amount from 1 g/L to 200 g/L, and a second polymeric surfactant comprising a polyalkylene glycol ether in an amount from 1 g/L to 200 g/L; and
d) optionally, other inert formulation ingredients.

7. The emulsion of claim 1 which comprises:
a) a discontinuous oil phase comprising from 1 g/L to 700 g/L of triclopyr butoxyethyl ester;
b) a continuous aqueous phase comprising from 100 g/L to 990 g/L of water and from 1 g/L to 300 g/L of a salt of aminopyralid;
c) from 1 g/L to 200 g/L of a first polymeric surfactant comprising an ABA block copolymer having a hydrophilic portion of polyethylene oxide (PEG) and a hydrophobic portion of 12-hydroxystearic acid, and from 1 g/L to 200 g/L of a second polymeric surfactant comprising a polyalkylene glycol ether; and
d) optionally, other inert formulation ingredients.
